(19) United States
(12) Patent Application Publication
(10) Pub. No.: US 2022/0074160 A1
(43) Pub. Date: Mar. 10, 2022

(54) PILE-CYLINDER-TRUSS COMPOSITE OFFSHORE WIND TURBINE FOUNDATION AND CONSTRUCTION PROCESS THEREOF

(71) Applicant: ZHEJIANG UNIVERSITY, ZHEJIANG (CN)

(72) Inventors: Ronghua ZHU, Zhejiang (CN); Lizhong WANG, Zhejiang (CN); Fuming WANG, Zhejiang (CN)

(73) Assignee: ZHEJIANG UNIVERSITY, ZHEJIANG (CN)

(21) Appl. No.: 17/418,851

(22) PCT Filed: Jun. 24, 2020
(86) PCT No.: PCT/CN2020/097840

§ 371 Date: Jun. 28, 2021

(30) Foreign Application Priority Data
Jul. 19, 2019 (CN) 201910655112.3

(51) Int. Cl. E02D 27/52; E02D 27/42; E02B 17/02

(52) U.S. Cl. CPC E02D 27/52; E02B 2017/0091; E02B 17/027; E02D 27/425

(57) ABSTRACT

Disclosed is a pile-cylinder-truss composite offshore wind turbine foundation. The pile-cylinder-truss composite offshore wind turbine foundation includes a truss structure, a suction cylinder and a pile foundation. The suction cylinder is connected to a bottom portion of the truss structure, and an embedded sleeve for mounting the pile foundation is provided on the suction cylinder. The embedded sleeve is located inside, at an edge of or outside the suction cylinder. The present invention also provides a construction process of the pile-cylinder-truss composite offshore wind turbine foundation.

### BACKGROUND

### Technical Field

The invention relates to the field of offshore wind power engineering, and in particular to a pile-cylinder-truss composite offshore wind turbine foundation and a construction process thereof.

### Description of Related Art

Offshore wind power, as a renewable energy source, has been vigorously studied and promoted by countries all over the world in recent years. The negative pressure cylinder (suction cylinder) is a large-diameter cylindrical thin-walled structure. As a form of anchoring and foundation, the negative pressure cylinder has been widely used in the offshore structure mooring system, offshore foundation platform and offshore wind turbine foundation, and has the advantages of simple assembly, high construction efficiency and low cost.

For example, a Chinese patent document with the publication number CN109914460A discloses a novel wind power foundation with suction cylinder composite structure suitable for shallow sea, and relates to the technical field of wind power generation. The system includes a central pile, a suction cylinder, a cylinder wall, a top cover, silo partition plates, steel stiffeners, a tower connecting section and studs. The suction cylinder is formed by enclosing a cylinder wall and a top cover, and three silo partition plates are provided in the cylinder to form a suction cylinder cavity. The cylinder wall, the top cover and the silo partition plates are all made of double-layer reinforced concrete slab, and the side where the steel plate contacts the concrete is welded with studs to strengthen the connection. The central pile is made of solid concrete filled steel tube or empty steel tube, and the top and side of the pile are firmly connected to the top cover and the silo partition plates respectively. The upper part of the top cover is provided with a tower connecting section, and steel stiffeners are provided along the circumferential direction, and the steel stiffeners are closely connected to the top cover and the tower connecting section. For example, a Chinese patent document with the publication number CN109853609A discloses an offshore wind power composite foundation. The offshore wind power composite foundation includes a jacket, a steel pipe pile, a suction cylinder and steel cables. The offshore wind power combined foundation of the present invention consists of a jacket, a steel pipe pile, a suction cylinder and a steel cable. The jacket and the suction cylinder are connected by a steel cable. The steel cable can exert its high tensile strength and increase the lateral stiffness of the composite foundation. The jacket bears vertical load, and the horizontal load and wave-current force of the wind turbine borne by the jacket are transmitted to the suction cylinder through the steel cable. As the suction cylinder is dispersed and embedded in the topsoil, the contact area with the topsoil foundation is large, which can give full play to the horizontal resistance of topsoil, improve the horizontal bearing capacity of foundation pile, improve the overturning resistance of foundation, and reduce the pulling force borne by the main legs of the jacket, thus reducing the distance between the main legs of the jacket and the cross section of rod pieces, and reducing the foundation cost and construction difficulty. The suction cylinder can be sunk by negative pressure, which makes the construction easy.

In the field of offshore wind power, generally three or more suction cylinders are connected to the truss steel frame to form the foundation of the suction cylinder truss wind turbine. The foundation is limited by the seabed geological conditions in the mounting sea area, so it is suitable for mounting in areas with relatively stable geological structure. During mounting, it is necessary to ensure that multiple cylinders sink at the same time. In addition, the suction cylinder foundation needs to be controlled to sink to a designed depth, and the verticality of the structure and the levelness of the whole superstructure should be accurately controlled during sinking. With the increase of water depth, soil plug uplift or even buckling is prone to form in the cylinder, which leads to the failure of the suction cylinder to sink completely to the designed depth at the same time, and it is difficult to ensure the levelness of the structure, which is also a difficult point in the use of the truss foundation with a suction cylinder at present.

### SUMMARY

The object of the present invention is to provide a pile-cylinder-truss composite offshore wind turbine foundation, which can ensure that the structure of the offshore wind turbine foundation has higher stability and bearing capacity to better withstand extreme loads such as typhoons, and has strong seabed adaptability. The present invention also provides a construction process of the pile-cylinder-truss composite offshore wind turbine foundation, which can more effectively ensure that the suction cylinder sinks to the seabed according to the designed depth.

The present invention provides the following technical schemes.

A pile-cylinder-truss composite offshore wind turbine foundation comprises a truss structure, a suction cylinder and a pile foundation, wherein the suction cylinder is connected to a bottom portion of the truss structure, and an embedded sleeve for mounting the pile foundation is provided on the suction cylinder.

The embedded sleeve is located inside, at an edge of or outside the suction cylinder. The two ends of the embedded sleeve are open, and the position, length and diameter of the embedded sleeve are determined according to the actual situation. The embedded position of the sleeve should ensure the overall strength of the structure, and should facilitate the mounting of the suction cylinder and the like. Generally, it should be as far away from the position of the pile leg as possible. The downward extension length of the sleeve should ensure the tightness of the suction cylinder, and the lower end of the suction cylinder is usually higher than the lower end of the suction cylinder. The length of the upper end of the sleeve shall be convenient for using a pile hammer to carry out piling construction.

A solidified grouting layer is provided between the embedded sleeve and the pile foundation. The pile foundation may be a steel pile or a pile foundation of other suitable materials and types. The connection and fixation between embedded sleeve and pile foundation can be strengthened by the grouting layer.

When the embedded sleeve is located inside or at the edge of the suction cylinder, reinforcing members for supporting the suction cylinder and connecting the suction cylinder with the embedded sleeve are provided in the suction cylinder. The reinforcing members usually use reinforcing ribs made of steel plates, H-shaped steels and T-shaped steels.

A top end of the suction cylinder is provided with a pump interface for connecting a suction pump or a suction pipeline. For the design of the pump interface, the design of the general suction cylinder structure can be referred to, and the position of the interface should be determined to ensure the overall strength of the cylinder body and facilitate the pumping operation of the suction cylinder.

The truss structure comprises a jacket structure for bearing the wind turbine and a tower, and the jacket structure comprises a plurality of jacket legs. The plurality of jacket legs mean that the bottom connection of the jacket structure is three legs, four legs or more legs. And the jacket legs are in one-to-one correspondence with the suction cylinders.

The jacket legs are connected to a top end of the suction cylinder through reinforcing members. The reinforcing members usually use reinforcing ribs made of steel plates, H-shaped steels and T-shaped steels.

The number of the jacket legs is at least three.

The present invention also provides a construction process of the pile-cylinder-truss composite offshore wind turbine foundation. The construction process includes the following steps.

(1) Hoisting the truss structure and the suction cylinder connected to the bottom portion of the truss structure to a seabed, wherein after contacting the seabed, the truss structure and the suction cylinder penetrate the seabed until a bottom end of the embedded sleeve is immersed in soil, and a closed space is formed in the suction cylinder.

(2) Pumping the suction cylinder through the suction pump or the suction pipeline, such that the suction cylinder sinks to a specified elevation, shutting down the suction pump after the suction cylinder reaches the specified elevation, and sealing the pump interface through a cover plate or grouting measures to complete mounting of the suction cylinder.

(3) Inserting the pile foundation into the embedded sleeve after the suction cylinder is mounted, and grouting a gap between the pile foundation and the embedded sleeve after pile sinking is completed.

In the step (2), an underwater suction pump can be used to pump water after being connected to the pump interface. According to the actual situation, one or more suction pumps can be mounted at the top end of each suction cylinder, and a centralized control system is adopted to control the pressure of the suction pumps to ensure that the cylinders of multiple suction cylinders sink synchronously. The water suction system can also be used to connect the suction pipeline to the pump interface 6 at the top end of each suction cylinder to sink the cylinder to the specified elevation.

In the step (2), when the suction cylinder does not sink to the specified elevation or does not meet structural level requirements after pumping the suction cylinder through the suction pump or the suction pipeline, knocking the embedded sleeve by a pile hammer to complete sinking and leveling operations.

In the step (3), the connection strength between the pile foundation and the embedded sleeve can be ensured by grouting the gap between the pile foundation and the embedded sleeve. The arrangement of the pile foundation can also increase the bearing capacity of the entire offshore wind turbine foundation.

According to the pile-cylinder-truss composite offshore wind turbine foundation provided by the present invention, during use, the external load borne by the structure is mainly resisted by the friction between the outer side of the suction cylinder, the outer side of the embedded sleeve, the outer side of the steel pile and the soil mass and the pressure difference inside and outside the suction cylinder.

The invention provides a truss-type wind turbine foundation with a combination of a suction cylinder and a pile foundation, and proposes a method and technology that is convenient for offshore construction. The offshore wind turbine foundation and construction process provided by the present invention can effectively ensure that the suction cylinder sinks to the seabed according to the designed depth. Once the geology is hard or the impervious bed exists, and the construction can not reach the designed depth through dead weight and negative pressure, the whole structure can be constructed to the designed depth with the help of the embedded sleeve and the external force of the construction hammer acting on the embedded sleeve structure. In order to improve the bearing capacity and long-term stability of the structure, the pile foundation can be inserted into the embedded sleeve, and the pile foundation and the embedded sleeve can be connected by grouting. The pile-cylinder-truss composite offshore wind turbine foundation provided by the present invention can ensure that the foundation structure has higher stability and bearing capacity, can better resist extreme loads such as typhoons, has the advantages of good seabed adaptability, simple and convenient mounting, low cost, reusability and the like, and has broad application prospects.

Compared with the traditional suction cylinder foundation and pile foundation structure, the advantages and innovations of the pile-cylinder-truss composite foundation are as follows.

1) Good seabed adaptability: it can be used for sandy soil geology, multi-layer geology of sandy soil and clay, and also for construction in geology with thick mollisol cover and weak bearing capacity.

2) High foundation reliability: it combines the advantages of traditional steel pile and novel suction cylinder foundation to provide sufficient bearing capacity.

3) Convenient construction: the truss structure itself sits on the seabed, and no auxiliary platform or structure is needed to stabilize the truss foundation.

### BRIEF DESCRIPTION OF THE DRAWINGS

FIG. 1 is a structural schematic diagram of a pile-cylinder-truss composite offshore wind turbine foundation provided in Embodiment I;

FIG. 2 is a schematic structural diagram of a suction cylinder and a pile foundation provided in Embodiment I;

FIG. 3 is a schematic top view of the suction cylinder and the pile foundation provided in Embodiment I;

FIG. 4 is a structural schematic diagram of a pile-cylinder-truss composite offshore wind turbine foundation provided in Embodiment II;

FIG. 5 is a schematic structural diagram of a suction cylinder and a pile foundation provided in Embodiment II;

FIG. 6 is a schematic top view of the suction cylinder and the pile foundation provided in embodiment II;

FIG. 7 is a structural diagram of a pile-cylinder-truss composite offshore wind turbine foundation provided in Embodiment III;

FIG. 8 is a schematic structural diagram of a suction cylinder and a pile foundation provided in Embodiment III;

FIG. 9 is a schematic top view of the suction cylinder and the pile foundation provided in Embodiment III.

### DESCRIPTION OF THE EMBODIMENTS

In order to make the object, technical scheme and advantages of the present invention clearer, the present invention will be further described in detail with reference to the drawings and embodiments. It should be understood that the specific embodiments described here are only used to explain the present invention, and do not limit the scope of protection of the present invention.

### Embodiment I

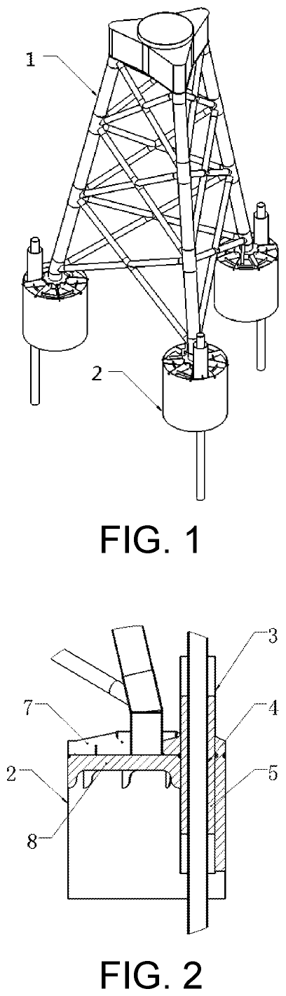

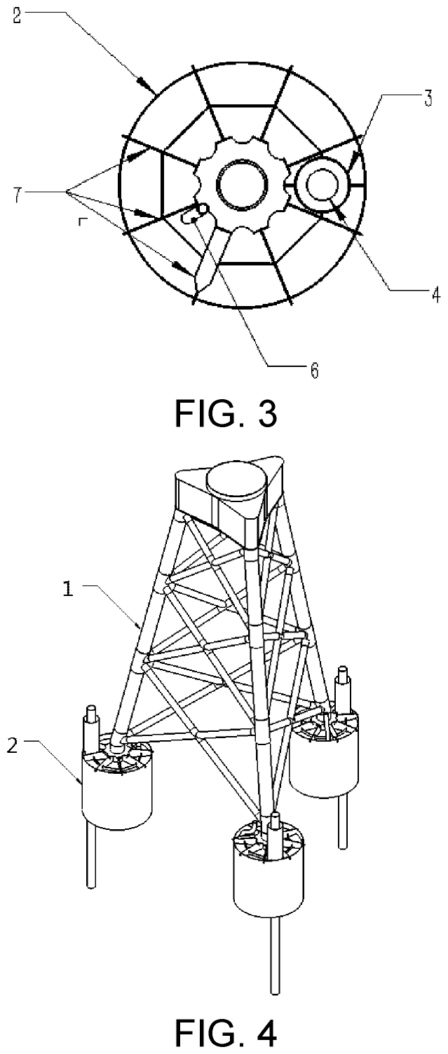

As shown in FIGS. 1-3, the pile-cylinder-truss composite offshore wind power foundation structure provided in this embodiment consists of two parts, a truss structure 1 at the upper part and a combined part of the suction cylinder and pile foundation at the lower part.

The truss structure 1 includes any jacket structure that can be used for bearing wind turbines and towers, and the bottom connection form of the jacket is three jacket legs.

The structure of the combined part of the suction cylinder 3 and the pile foundation 4 comprises a cylindrical thin-walled suction cylinder 2 with an open lower part, and the top end of the suction cylinder 2 is connected to the jacket legs through reinforcing members 7. An embedded sleeve 3 for mounting pile foundation 4 is provided in the suction cylinder 2, and the embedded sleeve 3 is connected to the suction cylinder 2 through reinforcing members 8. The two ends of the embedded sleeve 3 are open. The position, length and diameter of the embedded sleeve are determined according to the actual situation. The inner part of the suction cylinder 2 is also provided with reinforcing members 8 to ensure the connection between the suction cylinder 2 and the embedded sleeve 3. The pile foundation 4 can be driven into the seabed through the embedded sleeve 3 to increase the bearing capacity of the foundation structure, and the pile foundation 4 is connected to the embedded sleeve 3 through the grouting layer 5. The top end of the suction cylinder 3 is provided with a pump interface 6 for connecting with an underwater suction pump.

### Embodiment II

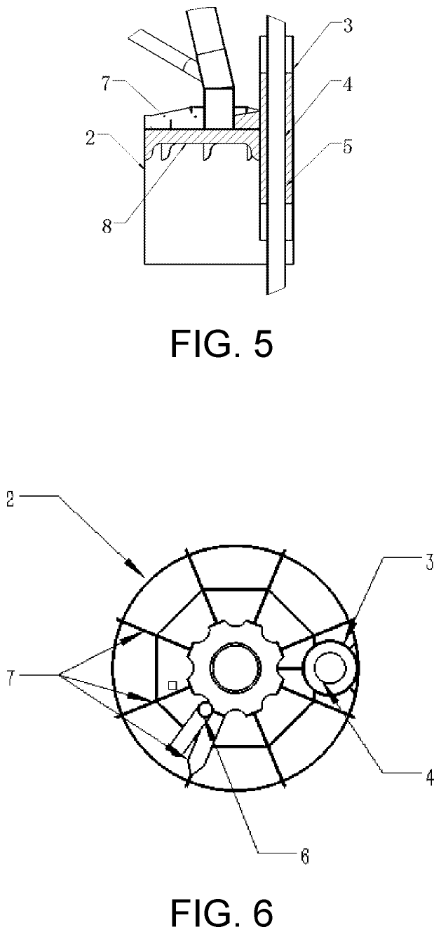

As shown in embodiment I and FIGS. 4-6, a pile-cylinder-truss composite offshore wind power foundation provided in this embodiment is different in that an embedded sleeve 3 is provided at the edge of the suction cylinder 2. The edge of the cylinder means that the suction cylinder 2 is tangent to the embedded sleeve 3.

### Embodiment III

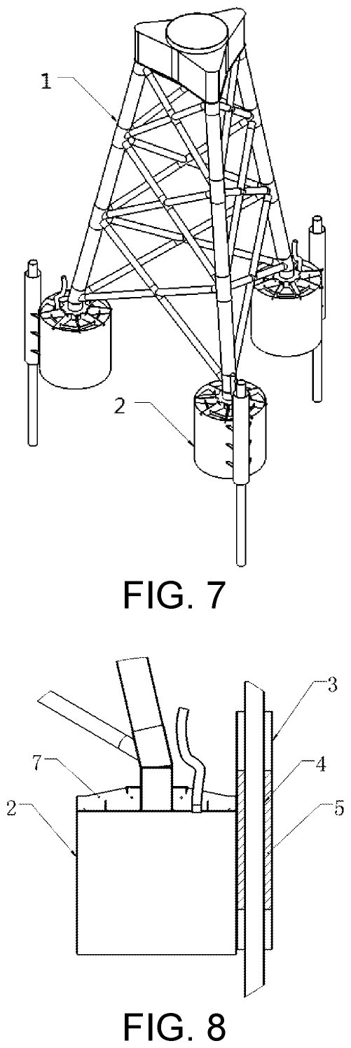

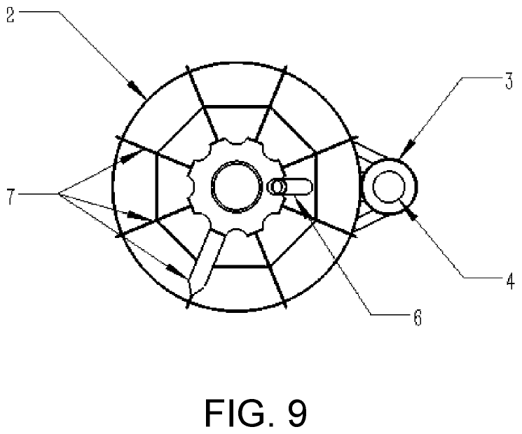

As shown in embodiment I and FIGS. 7-9, a pile-cylinder-truss composite offshore wind power foundation provided in this embodiment is different in that an embedded sleeve 3 is provided outside the suction cylinder 2, and there is no need for a reinforcing member connected to the embedded sleeve 3 in the suction cylinder 2.

The construction process of the pile-cylinder-truss composite offshore wind turbine foundations provided in Embodiments 1-3 includes the following steps.

(1) Hoisting the truss structure and the suction cylinder connected to the bottom portion of the truss structure to the seabed, wherein the truss structure and the suction cylinder penetrate the seabed after contacting the seabed until a bottom end of an embedded sleeve is immersed in soil, thus forming a closed space in the suction cylinder.

(2) Pumping the suction cylinder by an underwater suction pump, such that the suction cylinder sinks to a specified elevation, shutting down the suction pump after the suction cylinder reaches the specified elevation, and sealing the pump interface through a cover plate or grouting measures to complete the mounting of the suction cylinder. When the suction cylinder does not sink to the specified elevation or does not meet structural level requirements after pumping the suction cylinder through the suction pump or the suction pipeline, the embedded sleeve is knocked by a pile hammer to complete sinking and leveling operations.

(3) Inserting the pile foundation into the embedded sleeve after the suction cylinder is mounted, and grouting a gap between the pile foundation and the embedded sleeve after pile sinking is completed.

The technical schemes and beneficial effects of the present invention in detail have been described in the above specific embodiments. It should be understood that the above embodiments are only the most preferred embodiment of the present invention, and are not intended to limit the present invention. Any modification, supplement and equivalent substitution made within the principle scope of the present invention should fall within the protection scope of the present invention.

1. A pile-cylinder-truss composite offshore wind turbine foundation, comprising a truss structure, a suction cylinder and a pile foundation, wherein the suction cylinder is connected to a bottom portion of the truss structure, and an embedded sleeve for mounting the pile foundation is provided on the suction cylinder.

2. The pile-cylinder-truss composite offshore wind turbine foundation according to claim 1, wherein the embedded sleeve is located inside, at an edge of or outside the suction cylinder.

3. The pile-cylinder-truss composite offshore wind turbine foundation according to claim 2, wherein a solidified grouting layer is provided between the embedded sleeve and the pile foundation.

4. The pile-cylinder-truss composite offshore wind turbine foundation according to claim 2, wherein when the embedded sleeve is located inside or at the edge of the suction cylinder, reinforcing members are provided in the suction cylinder for supporting the suction cylinder and connecting the suction cylinder with the embedded sleeve.

5. The pile-cylinder-truss composite offshore wind turbine foundation according to claim 1, wherein a top end of the suction cylinder is provided with a pump interface for connecting a suction pump or a suction pipeline.

6. The pile-cylinder-truss composite offshore wind turbine foundation according to claim 1, wherein the truss structure comprises a jacket structure for bearing a wind turbine and a tower, and the jacket structure comprises a plurality of jacket legs.

7. The pile-cylinder-truss composite offshore wind turbine foundation according to claim 6, wherein the jacket legs are connected to a top end of the suction cylinder through reinforcing members.

8. The pile-cylinder-truss composite offshore wind turbine foundation according to claim 6, wherein a number of the jacket legs is at least three.

9. A construction process of pile-cylinder-truss composite offshore wind turbine foundation according to claim 1, wherein the construction process comprising the following steps:
step (1): hoisting the truss structure and the suction cylinder connected to the bottom portion of the truss structure to a seabed, wherein after contacting the seabed, the truss structure and the suction cylinder penetrate the seabed until a bottom end of the embedded sleeve is immersed in soil, and a closed space is formed in the suction cylinder;
step (2): pumping the suction cylinder through a suction pump or a suction pipeline, such that the suction cylinder sinks to a specified elevation, shutting down the suction pump after the suction cylinder reaches the specified elevation, and sealing a pump interface through a cover plate or grouting measures to complete mounting of the suction cylinder; and
step (3): inserting the pile foundation into the embedded sleeve after the suction cylinder is mounted, and grouting a gap between the pile foundation and the embedded sleeve after pile sinking is completed.

10. The construction process of pile-cylinder-truss composite offshore wind turbine foundation according to claim 9, wherein in the step (2), when the suction cylinder does not sink to the specified elevation or does not meet structural level requirements after pumping the suction cylinder through the suction pump or the suction pipeline, knocking the embedded sleeve by a pile hammer to complete sinking and leveling operations.
